(19) United States
(12) Patent Application Publication
(10) Pub. No.: US 2010/0136804 A1
(43) Pub. Date: Jun. 3, 2010

(54) Electrical Interconnection System

(75) Inventor: Julie N. Strickland, McKinney, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/628,729

(22) Filed: Dec. 1, 2009

Related U.S. Application Data
(60) Provisional application No. 61/200,710, filed on Dec. 2, 2008.

(51) Int. Cl. H01R 12/14

(52) U.S. Cl. 439/65

(57) ABSTRACT

According to one embodiment, an electrical interconnection system includes multiple first electrical contacts and multiple second electrical contacts alternatively meshed together using a slider. The first electrical contacts are configured on a first substrate and electrical coupled to a first electrical circuit, while the second electrical contacts are configured on a second substrate and electrical coupled to a second electrical circuit. When meshed together, the first electrical contacts and second electrical contacts electrically couple the first electrical circuit to the second electrical circuit.

### RELATED APPLICATIONS

This application claims priority to U.S. Provisional Patent Application Ser. No. 61/200,710, entitled “ELECTRICAL INTERCONNECTION SYSTEM,” which was filed on Dec. 2, 2008. U.S. Provisional Patent Application Ser. No. 61/200,710 is hereby incorporated by reference.

### TECHNICAL FIELD OF THE DISCLOSURE

This disclosure generally relates to electrical devices, and more particularly, to an electrical interconnection system that may be used to electrically couple electrical circuits together.

### BACKGROUND OF THE DISCLOSURE

Complex electrical systems are often designed to have multiple subsystems that are electrically coupled together to perform some useful function. Each subsystem usually performs a portion of the overall functionality of its electrical system. The design of electrical systems with multiple subsystems may allow designers to accommodate these electrical systems in various types of enclosures. Multiple subsystems may also provide an efficient approach for periodic upgrading of the various functional elements of the electrical system without affecting other portions of the electrical system.

### SUMMARY OF THE DISCLOSURE

According to one embodiment, an electrical interconnection system includes multiple first electrical contacts and multiple second electrical contacts alternatively meshed together using a slider. The first electrical contacts are configured on a first substrate and electrical coupled to a first electrical circuit, while the second electrical contacts are configured on a second substrate and electrical coupled to a second electrical circuit. When meshed together, the first electrical contacts and second electrical contacts electrically couple the first electrical circuit to the second electrical circuit.

Some embodiments of the disclosure may provide numerous technical advantages. For example, one embodiment of the electrical interconnection system may provide denser packaging of electrical systems comprising multiple subsystems. Known interconnection systems use separate connectors for electrically coupling subsystems together. Known implementations of connectors, however, are relatively large in size and may be cumbersome to work with when physically coupled to flex circuits that are have a relatively thin profile. The electrical interconnection system according to the teachings of the present disclosure is such that subsystems may be interconnected in relatively denser enclosures due than provided by known electrical connectors that are relatively bulkier in shape.

Some embodiments may benefit from some, none, or all of these advantages. Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1A is a plan view showing one embodiment of the electrical interconnection system according to the teachings of the present disclosure;

FIG. 1B is an enlarged perspective view of the electrical interconnection system of FIG. 1A showing its teeth in the coupled position and its pull tab removed from the eyelet of its slider;

FIGS. 2A is a perspective of another embodiment of the electrical interconnection system in which a zipper has been removed to reveal an insulative membrane that insulates adjacent zippers; and

FIG. 2B is a side elevational view of the electrical interconnection system of FIG. 2A.

### DETAILED DESCRIPTION OF EXAMPLE EMBODIMENTS

It should be understood at the outset that, although example implementations of embodiments are illustrated below, various embodiments may be implemented using any number of techniques, whether currently known or not. The present disclosure should in no way be limited to the example implementations, drawings, and techniques illustrated below. Additionally, the drawings are not necessarily drawn to scale.

Complex electrical systems are often configured with multiple subsystems that function together to perform a useful function. These subsystems are usually coupled together using electrical interconnection systems that electrically couple certain nodes of one subsystem to those of another. One particular type of electrical interconnection system includes a flex circuit having one or more copper traces configured on a flexible substrate. The flexibility of the flex circuit provides electrical interconnection between subsystems without constraining the physical layout between them. In many cases, flex circuits may use approximately 75 percent less volume than cable bundles that accomplish the same purpose.

Interconnection of electrical circuits to one another is usually provided by connectors configured on an end of an electrical circuit. Conventional connectors typically have a generally rigid structure, which may present various design problems when used in conjunction with electrical circuits, such as flex circuits having a generally flexible structure. For example, as a result of using such conventional rigid connectors, special designs may need to be created which in turn can consume space. With such difficulties, certain embodiments recognize that an electrical interconnection system may be implemented requiring relatively less space than conventional connectors and may be coupled and/or separated in a relatively quick manner.

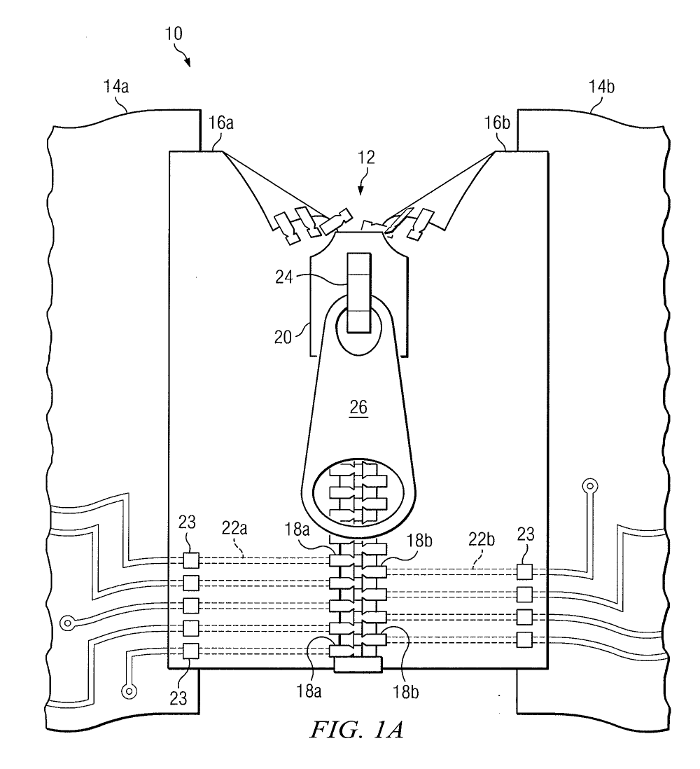

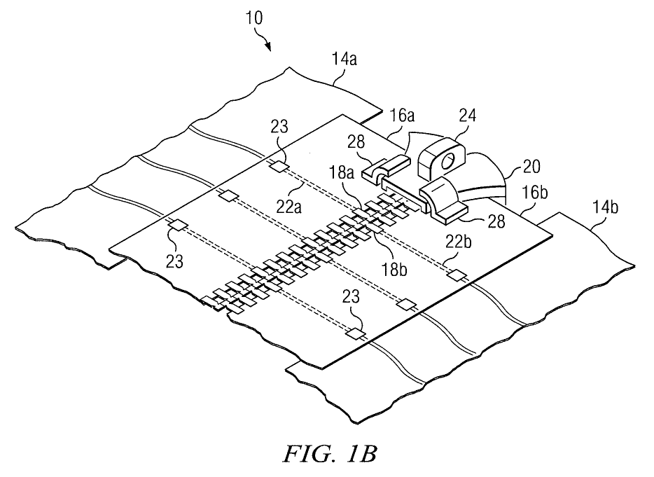

FIG. 1A is a plan view showing one embodiment of an electrical interconnection system 10 according to the teachings of the present disclosure. Electrical interconnection system 10 includes a zipper 12 or other similar device that is configured to form an electrical connection between two electrical circuits 14a and 14b. Zipper 12 includes two complementary substrates 16a and 16b that each have a row of teeth 18a and 18b arranged in a generally linear fashion along one of its edges. Zipper 12 also includes a slider 20 that engages a portion of each row of teeth 18a and 18b for alternatively meshing and separating the two rows of teeth 18a and 18b from one another. Electrical interconnection of electrical circuit 14a to electrical circuit 14b is provided by one or more conductors 22a and 22b on each substrate 16a and 16b that electrically couple one or more teeth 18a and 18b to a corresponding one or more nodes on each electrical circuit 14a and 14b, respectively.

Electrical circuits 14a and 14b may be any suitable type for which electrical interconnection between the two may be desired. Some embodiments of electrical circuits 14a and 14b may include, but not limited to, printed wiring boards (PWBs), flex circuits, flex rigid circuits, rigid circuits, circuit card assemblies (CCAs), cable bundles, and/or any combination thereof. For example, electrical circuit 14a may be a generally rigid printed wiring board functioning as a mother board, while electrical circuit 14b may be a generally rigid printed wiring board functioning as a daughter card. As another example, electrical circuit 14a may be a flex circuit having a generally flexible structure, while electrical circuit 14b may be a cable bundle comprising multiple elongated wires that terminate at substrate 16b.

Substrates 16a and 16b may be coupled to electrical circuits 14a and 14b in any suitable manner. In a particular embodiment in which electrical circuits 14a and 14b comprise flex circuits, substrates 16a and 16b may be flex circuits at their end or they may be coupled to flex circuits at a point along their extent that is not at their end. In another embodiment, substrates 16a and 16b may be coupled to flex circuits such that when coupled, one or both flex circuits are maintained in a generally bent configuration. For example, electrical interconnection system 10 may be implemented to electrically couple two flex circuits together, such that when coupled, one flex circuit remains bent to accommodate its configuration in a chassis or other type of housing.

Certain embodiments of electrical interconnection system 10 may provide advantages over other interconnection systems. For example, flex circuits typically include substrates formed of a flexible material. Known interconnection systems, however, may be generally rigid in nature, thus defeating the purpose of the flex circuit. Additionally, these known interconnection systems may be relatively large in size which may increase costs and decrease yields. Certain embodiments of the electrical interconnection system 10 according to the teachings of the present disclosure may provide a solution to this problem by providing a relatively flexible electrical coupling system with reduced volume for decreased costs and increased yields.

Certain embodiments of the electrical interconnection system 10 may also provide an advantage when implemented on circuit card assemblies that are relatively large or have a complex shape. In this case, the electrical interconnection system 10 may allow electrical coupling with other substrates in a side-by-side fashion while maintaining a relatively lower profile than other electrical interconnection systems.

Each substrate 16a and 16b has multiple conductors 22a and 22b that function as nodes of an associated subsystem (not shown). Conductors 22a and 22b may be electrically coupled to electrical circuits 14a and 14b in any suitable manner. In one embodiment, electrical circuits 14a and 14b and conductors 22a and 22b include plated through holes for electrical interconnection to each other using a relatively short section of wire that may be soldered into their plated through holes. In another embodiment, electrical circuits 14a and 14b and conductors 22a and 22b include exposed contact surfaces 23 for electrical connection to one another using surface mount soldering techniques. In another embodiment, electrical circuits 14a and 14b and conductors 22a and 22b may be electrically coupled to each other using compliant pins. In yet another embodiment, electrical circuits 14a and 14b and conductors 22a and 22b include relatively short protruding wires or other conducting appendages for forming splice interconnections in which each conductor 22a or 22b has an exposed section of wire that may be soldered to an exposed section of wire of electrical circuit 14a or 14b.

In the particular embodiment shown, conductors 22a and 22b comprise wires or traces that are generally linear in shape. In other embodiments, conductors 22a and 22b may be any suitable shape and made of a material that is electrically conductive in nature. In another embodiment, conductors 22a and 22b comprise copper traces that are disposed on substrates 16a and 16b formed of a flexible material, such as a polyimide material, carbon fiber reinforced (CFR) material, Mylar, or other material having relatively similar characteristics. Substrates 16a and 16b may be generally dielectric in nature to insulate conductors 22a and 22b from one another and from the environment using multiple layers.

In one embodiment, substrates 16a and 16b may be formed of a dielectric material such as fabric in which electrical interconnection system 10 may be incorporated into an article of clothing. In this manner, a wire bundle routed through the clothing may be selectively coupled to another wire bundle configured in the clothing. For example, a particular article of clothing may be configured with a control circuit that controls the operation of various electrical components configured at different locations in the clothing. Use of the electrical interconnection system 10 may provide a connect/disconnect feature for the control circuit and/or electrical components that allows their installation and removal from the clothing in a relatively quick and easy manner.

Certain embodiments incorporating substrates 16a and 16b that are flexible may provide an advantage in that movement of slider 20 along substrates 16a and 16b may allow their flexure toward and away from one another while electrically coupling or decoupling teeth 18a and 18b. That is, the flexible nature of electrical circuits 14a and 14b provides a relatively small amount of bending for meshing of teeth 18a and 18b by slider 18.

In the particular embodiment, slider 18 alternatively meshes and separates a plurality of teeth 18a and 18b configured on electrical circuits 14a and 14b, respectively. In one embodiment, slider 18 has a generally Y-shaped channel that meshes teeth 18a and 18b with one another when slid in one direction along the end of electrical circuits 14a and 14b and separates teeth 18a and 18b when slid in the opposing direction. In other embodiments, slider 18 may have any suitable shape for alternatively coupling and decoupling teeth 18a with teeth 18b.

Teeth 18a and 18b have any shape such that when meshed, they physically bind with one another along the edges of substrates 16a and 16b. For example, teeth 18a and 18b may have a bowl shape in which their convex surface binds with the concave surface of other teeth 18a and 18b to maintain physical and electrical coupling. As another example, teeth 18a and 18b may have a T-shape in which each tooth 18a and 18b interlocks with its adjacent tooth 18a and 18b. In some embodiments, each tooth 18a and 18b may be resilient to provide a spring-like compression force on its adjacent tooth 18a and 18b.

In one embodiment, slider 20 includes an eyelet 24 for removable engagement of a pull tab 26. Pull tab 26 has any suitable shape that may grasped by the fingers of a user for movement of slider 20 along teeth 18a and 18b. In other embodiments, pull tab 26 may be permanently engaged on slider 18, or slider 20 may be void of eyelet 24 in which movement of slider 20 may be facilitated by other suitable mechanisms, such as pliers or other suitable device that grasps slider 20 for directing its movement.

Certain embodiments incorporating a removable pull tab 26 may provide an advantage in that an inadvertent snags and/or electrical short circuit conditions may be avoided by selective removal of pull tab 26. For example, pull tab 26 may be engaged on eyelet 24 in a manner that allows it to dangle from eyelet 24. This structure forms a relatively insecure arrangement in which pull tab 26 may inadvertently become snagged on other mechanism proximate zipper 12 during its use. If pull tab 26 is conductive, it may inadvertently come in contact with conductors 16a or 16b or teeth 18a and 18b thus forming a short circuit condition. Thus, removal of pull tab 26 may reduce or eliminate potential fault conditions that may hamper the reliability of electrical interconnection system 10 in some embodiments.

A few, most, or all teeth 18a and 18b may be made of a conductive material, such as metal, to function as electrical contacts for selectively coupling conductors 16a to conductors 16b when teeth 18a and 18b are meshed together. Teeth 18a and 18b are electrically coupled to their respective conductors 22a and 22b in any suitable manner. In one embodiment, teeth 18a and 18b are electrically coupled to their respective conductors 22a and 22b using a soldering process or by application of an electrically conductive adhesive. In some embodiments, additional adhesive, such as epoxy may be added to the junction of teeth 18a and 18b and their respective conductors 22a and 22b to enhance the structural integrity of the connection.

In one embodiment, adjacent teeth 18a and 18b on each substrate 16a and 16b are independently coupled to its own conductor 22a and 22b. In this case, one side of each tooth 20a and 20b may be coated with an insulative material to electrically isolate adjacent teeth 18a and 18b from one another. The insulative material may be a compressible material to provide a spring-like compressive force against adjacent teeth 18a and 18b.

In other embodiments, certain teeth 18a and 18b may be conductive while other teeth 18a and 18b may be insulative for insulating conductive teeth 18a and 18b from one another. For example, alternating teeth 18a and 18b may be insulative and conductive. That is, every other tooth 20a and 20b along the extent of their respective substrate 16a and 16b may be insulative to electrically isolate conductive teeth 18a and 18b from one another. In another example, every third or greater tooth 18a and 18b along substrate 16a and/or 16b may be insulative such that multiple adjacent teeth 18a and 18b between insulative teeth 18a and 18b may be electrically coupled together for enhanced transmission of current through electrical interconnection system 10. In yet another example, random teeth 18a and 18b along substrates 16a and/or 16b may be insulative such that electrical interconnection system 10 may be tailored to suit a desired connection application.

FIG. 1B is an enlarged perspective view of the electrical interconnection system 10 of FIG. 1A showing the teeth 18a and 18b in the coupled position and pull tab 26 removed from the eyelet 24 of slider 20. As shown, zipper 12 includes a retention clamp for maintaining slider 18 at its desired position. Retention clamp generally includes two tabs 28 configured on complementary sides of substrates 16a and 16b. Tabs 28 may have a spring-loaded action such that movement of slider 20 across tabs 28 requires a specified amount of increased force relative to the force required for its normal movement along teeth 18a and 18b. This increased force may serve to maintain slider 20 in its desired position until slider 20 is moved away from tabs 28 using a snapping action. Tabs 28 may be attached to substrates 16a and 16b using any suitable attachment mechanism, such as screws or adhesives. Although the present embodiment describes retention clamp formed of two tabs 28 configured on both substrates 16a and 16b, other embodiments of retention clamp may include any type of mechanism that requires a specified amount of increased force for movement of slider 20 along teeth 18a and 18b.

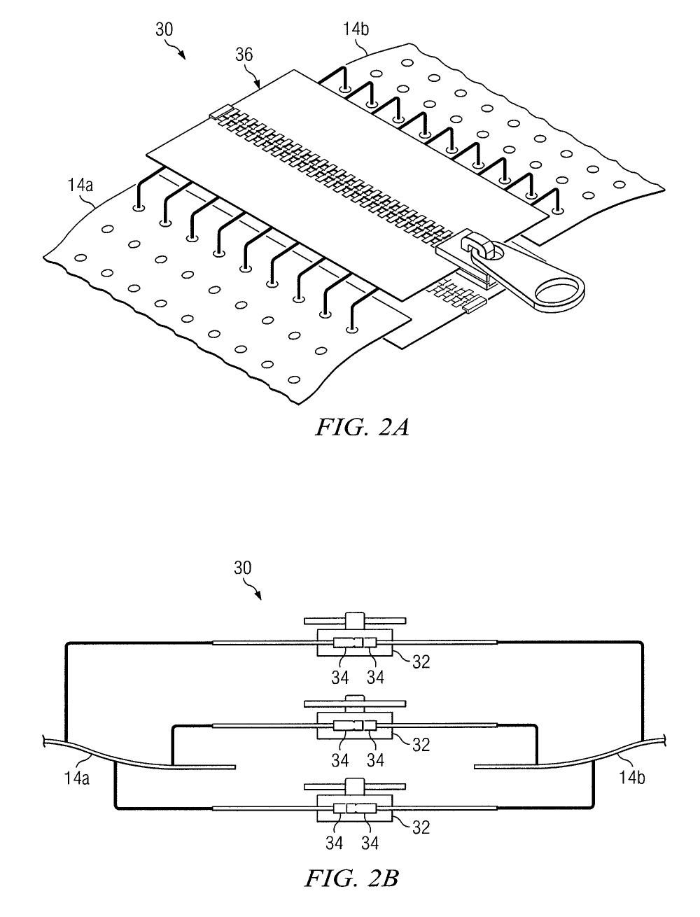

FIGS. 2A and 2B shows another embodiment of an electrical interconnection system 30 in which multiple zippers 32 may be configured on adjacent electrical circuits 14a and 14b. The design of each zipper 32 is similar in design and construction to the zipper 12 of FIG. 1. Each zipper 32 differs, however, in that the teeth 18a and 18b of each zipper 12 is configured on a small section of electrical circuit 34 which is itself, electrically coupled to a relatively larger electrical circuit 14a and 14b. In this particular embodiment, each zipper 32 may be electrically isolated from other zippers 32 using an electrically insulative membrane 36, such as tape.

Modifications, additions, or omissions may be made to electrical interconnection system 10 or 30 without departing from the scope of the disclosure. The components of electrical interconnection system 10 or 30 may be integrated or separated. For example, substrate 14a and/or substrate 14b may be coupled to its respective electrical circuit 14a and 14b as described above or may be integrally formed together such that substrate 16a and/or 16b also forms the substrate of electrical circuit 14a and 14b. Moreover, the operations of electrical interconnection system 10 or 30 may be performed by more, fewer, or other components. For example, certain embodiments of electrical interconnection system 10 or 30 may include additional elements, such as ground shields, that are disposed proximate certain conductor 22a and 22b for controlling their intrinsic impedance and/or reducing the effects of electro-magnetic induced noise. Thus, these certain conductors 22a and 22b may be configured to convey high frequency signals or other sensitive signals without undue attenuation due to impedance mismatch conditions on these conductors 22a and 22b. For example, a ground shield comprising a conductive material, such as metal, may be provided as a flap that is electrically grounded, and permanently attached to substrate 16a while being releasably attached to substrate 16b using hook-and-loop material. Thus, when substrate 16a is coupled to substrate 16b, the flap may pressed onto substrate 16b to hold the flap in a fixed position relative to conductors 22a and 22b. As used in this document, “each” refers to each member of a set or each member of a subset of a set.

Although the present disclosure and its advantages have been described in detail, it should be understood that various changes, substitutions, and alterations can be made therein without departing from the spirit and scope of this disclosure as defined by the appended claims.

What is claimed is:

1. An electrical interconnection system comprising:
a plurality of a first electrical contacts configured on a first substrate, the plurality of first electrical contacts electrically coupled to a first electrical circuit;
a plurality of a second electrical contacts configured on a second substrate, the plurality of second electrical contacts electrically coupled to a second electrical circuit; and
a slider operable to:
mesh the plurality of first electrical contacts with the plurality of second electrical contacts such that the first electrical circuit is electrically coupled to the second electrical circuit through the plurality of first electrical contacts and the plurality of second electrical contacts.

2. The electrical interconnection system of claim 1, wherein the plurality of first electrical contacts and the plurality of second electrical contacts are each arranged linearly on their respective first substrate and second substrate, the slider comprising a Y-shaped channel operable to:
engage a portion of first electrical contacts and a portion of the plurality of second electrical contacts; and
mesh the plurality of first electrical contacts and the plurality of second electrical contacts when the Y-shaped channel is moved across the plurality of first electrical contacts and the plurality of second electrical contacts.

3. The electrical interconnection system of claim 1, further comprising a plurality of first insulating contacts alternatively configured with the first electrical contacts on the first substrate and a plurality of second insulating contact alternatively configured with the second electrical contacts on the second substrate.

4. The electrical interconnection system of claim 1, wherein the plurality of first electrical contacts and the plurality of second electrical contacts comprise a plurality of first teeth and a plurality of second teeth, respectively, each first tooth and second tooth having an insulative coating opposite its first electrical contact or second electrical contact.

5. The electrical interconnection system of claim 1, wherein the first substrate and the second substrate comprise a flexible material selected from the group consisting of a polyimide material, a carbon fiber reinforced (CFR) material, and a Mylar material.

6. The electrical interconnection system of claim 5, further comprising a plurality of copper traces electrically coupling the plurality of first or second electrical contacts to the first or second electrical circuit, the plurality of copper traces formed on the first or second substrate.

7. The electrical interconnection system of claim 1, wherein the slider comprises an eyelet operable to be removably engaged with a pull tab.

8. A plurality of electrical interconnection systems of claim 1 that selectively couple the first electrical circuit to the second electrical circuit.

9. The electrical interconnection system of claim 1, further comprising a retention clamp configured on the first substrate and the second substrate, the retention clamp comprising a spring-loaded action for increased force of movement of the slider relative to its normal movement along the first electrical contacts and the second electrical contacts.

10. The electrical interconnection system of claim 1, wherein the slider is operable to separate the plurality of first electrical contacts from the plurality of second electrical contacts such that the first electrical circuit is decoupled from the second electrical circuit.

11. A method comprising:
providing an electrical interconnection system comprising a plurality of a first electrical contacts configured on a first substrate, the plurality of first electrical contacts electrically coupled to a first electrical circuit, a plurality of a second electrical contacts configured on a second substrate, the plurality of second electrical contacts electrically coupled to a second electrical circuit, and a slider;
meshing the plurality of first electrical contacts with the plurality of second electrical contacts such that the first electrical circuit is electrically coupled to the second electrical circuit through the plurality of first electrical contacts and the plurality of second electrical contacts.

12. The method of claim 11, wherein meshing the plurality of first electrical contacts with the plurality of second electrical contacts comprises engaging a portion of first electrical contacts and a portion of the plurality of second electrical contacts using a Y-shaped channel configured in the slider, and meshing the plurality of first electrical contacts and the plurality of second electrical contacts while the Y-shaped channel is moved across the plurality of first electrical contacts and the plurality of second electrical contacts.

13. The method of claim 11, wherein the electrical interconnection system further comprises a plurality of first insulating contacts alternatively configured with the first electrical contacts on the first substrate and a plurality of second insulating contact alternatively configured with the second electrical contacts on the second substrate.

14. The method of claim 11, wherein the plurality of first electrical contacts and the plurality of second electrical contacts comprise a plurality of first teeth and a plurality of second teeth, respectively, each first tooth and second tooth having a insulative coating opposite its first electrical contact or second electrical contact.

15. The method of claim 11, wherein the first substrate and the second substrate comprise a flexible material selected from the group consisting of a polyimide material, a carbon fiber reinforced (CFR) material, and a Mylar material.

16. The method of claim 15, wherein the electrical interconnection system further comprising a plurality of copper traces electrically coupling the plurality of first or second electrical contacts to the first or second electrical circuit, the plurality of copper traces formed on the first or second substrate.

17. The method of claim 11, wherein the slider comprises an eyelet operable to be removably engaged with a pull tab.

18. The method of claim 11, wherein providing an electrical interconnection system comprises providing a plurality of electrical interconnection systems that may each electrical couple the first electrical circuit to the second electrical circuit.

19. The method of claim 11, wherein meshing or separating the first plurality of teeth from the plurality of second teeth comprises providing an increased force of movement of the slider relative to its normal movement using a retention clamp configured on the first substrate and the second substrate.

20. The method of claim 11, further comprising separating the plurality of first electrical contacts from the plurality of second electrical contacts such that the first electrical circuit is decoupled from the second electrical circuit.

21. A zipper comprising:
a plurality of first teeth configured on a first substrate, at least one of the plurality of first teeth having a first electrical contact that is electrically coupled to a first electrical circuit;
a plurality of second teeth configured on a second substrate, at least one of the plurality of second teeth having a second electrical contact that is electrically coupled to a second electrical circuit; and
a slider operable to:
mesh the plurality of first teeth with the plurality of second teeth such that the first electrical circuit is electrically coupled to the second electrical circuit through the at least one electrical contact and the at least one second electrical contact.

22. The zipper of claim 21, wherein the plurality of first teeth have a plurality of first electrical contacts and a plurality of first insulating teeth alternatively configured with the plurality of first electrical contacts on the first substrate, the plurality of second teeth having a plurality of second electrical contacts and a plurality of second insulating teeth alternatively configured with the plurality of second electrical contacts on the second substrate.

23. The zipper of claim 21, wherein the plurality of first teeth have a plurality of first electrical contacts and a plurality of first insulative coatings opposite the plurality of first electrical contacts of each first teeth, the plurality of second teeth have a plurality of second electrical contacts and a plurality of second insulative coatings opposite the plurality of second electrical contacts of each second teeth

24. The zipper of claim 21, wherein the first substrate and the second substrate comprise a flexible material selected from the group consisting of a polyimide material, a carbon fiber reinforced (CFR) material, and a Mylar material.

25. The zipper of claim 24, further comprising at least one copper trace electrically coupling the at least one first or second electrical contact to the first or second electrical circuit, the at least one copper trace formed on the first or second substrate.

26. The zipper of claim 21, wherein the slider comprises an eyelet operable to be removably engaged with a pull tab.

27. A plurality of zippers of claim 21 that selectively couple the first electrical circuit to the second electrical circuit.

28. The zipper of claim 21, further comprising a retention clamp configured on the first substrate and the second substrate, the retention clamp comprising a spring-loaded action for increased force of movement of the slider relative to its normal movement along the plurality of first teeth and the plurality of second teeth.

29. The zipper of claim 21, wherein the slider is operable to separate the plurality of first teeth from the plurality of second teeth such that the first electrical circuit is electrically decoupled from the second electrical circuit.
